(19) United States
(12) Patent Application Publication
(10) Pub. No.: US 2017/0136967 A1
(43) Pub. Date: May 18, 2017

(54) METHOD FOR PREVENTING DISCHARGE OF BATTERY AT A TIME OF RE-PROGRAMMING OF VEHICLE CONTROLLERS

(71) Applicant: HYUNDAI MOTOR COMPANY, Seoul (KR)

(72) Inventors: Hyun Soo PARK, Anyang-si (KR); Jae Hoon CHO, Suwon-si (KR); Dae Ro PARK, Hwaseong-si (KR)

(21) Appl. No.: 15/238,260

(22) Filed: Aug. 16, 2016

(30) Foreign Application Priority Data
Nov. 13, 2015 (KR) 10-2015-0159950

(51) Int. Cl. B60R 16/023; B60R 16/03; B60R 16/04

(52) U.S. Cl. CPC B60R 16/0238; B60R 16/04; B60R 16/03

(57) ABSTRACT

A method for preventing a discharge of a battery at a time of re-programming of vehicle controllers includes starting the re-programming by the vehicle controllers, turning on a high voltage relay by a battery management system (BMS) among the vehicle controllers, charging an auxiliary battery by operating a low direct current (DC) to DC converter (LDC) among the vehicle controllers, stopping a controller area network (CAN) communication between the vehicle controllers, controlling a high voltage battery by the BMS, and stopping the charging of the auxiliary battery.

### CROSS-REFERENCE TO RELATED APPLICATION

This application claims the benefit of priority to Korean Patent Application No. 10-2015-0159950, filed on Nov. 13, 2015 with the Korean Intellectual Property Office, the disclosure of which is incorporated herein in its entirety by reference.

### TECHNICAL FIELD

The present disclosure relates to a method for preventing discharge of a battery at the time of re-programming of vehicle controllers, and more particularly, to a technology for controlling whether or not an auxiliary battery is charged by deciding an entry point in time of re-programming of vehicle controllers.

### BACKGROUND

Vehicles were originally controlled using mechanical means. However, in accordance with the development of the vehicle and technologies used in vehicles, various apparatuses provided in the vehicle have been increasingly controlled by electronic means.

Electronic control apparatuses of the vehicle may be controlled by various programs and algorithms. These programs and algorithms may be updated through re-programming with the passage of time.

In order to perform the re-programming of the vehicle, drivers should visit a specific facility such as a vehicle service center, or perform a remote operation.

In addition, since the re-programming of the vehicle may be uniformly performed by applying the same software to each vehicle even though detailed items such as driving distances, speeds, and maintenance states, are different from each other in each vehicle, inconvenience of the drivers has occurred.

Further, in the case in which power is blocked during the re-programming of the vehicle, the re-programming may not be completely performed, and there is a risk that the existing electronic control apparatuses of the vehicle may be damaged.

Particularly, when the electronic control apparatus of the vehicle is reprogrammed or software is updated for a long period of time in an ignition-on state of the vehicle, a problem such as a failure of the re-programming or a shut-down of the vehicle caused by discharge of an auxiliary battery may occur.

### SUMMARY

The present disclosure has been made to solve the above-mentioned problems occurring in the prior art while advantages achieved by the prior art are maintained intact.

An aspect of the present disclosure provides a method for preventing discharge of a battery at a time of re-programming of vehicle controllers capable of controlling whether or not an auxiliary battery is charged by deciding an entry point in time of the re-programming of the vehicle controllers.

According to an exemplary embodiment of the present disclosure, a method for preventing discharge of a battery at the time of re-programming of vehicle controllers may include: starting the re-programming by the vehicle controllers; turning on a high voltage relay by a battery management system (BMS) among the vehicle controllers; charging an auxiliary battery by operating a low direct current (DC) to DC converter (LDC) among the vehicle controllers; stopping a controller area network (CAN) communication between the vehicle controllers; controlling a high voltage battery by the BMS; and stopping the charging of the auxiliary battery.

The controlling of the high voltage battery may include: comparing a state of charge (SOC) of the high voltage battery with a preset SOC; and turning off the high voltage relay in a case in which the SOC of the high voltage battery is smaller than the preset SOC.

The step of charging the auxiliary battery may be maintained in the case in which the SOC of the high voltage battery is larger than the preset SOC.

In the step of starting the re-programming, when a system for re-programming the vehicle controllers does not enter a re-programming mode, the system for re-programming the vehicle controllers may enter a normal mode.

In the step of stopping the CAN communication between the vehicle controllers, CAN communication between vehicle controllers except for the BMS and the LDC may be stopped.

A process of performing the re-programming may include: deciding whether or not to enter a re-programming mode; allowing the vehicle controllers to enter the re-programming mode; stopping CAN communication between the vehicle controllers; performing the re-programming of the vehicle controllers; and resuming the CAN communication between the vehicle controllers.

The method for preventing discharge of a battery at a time of re-programming of vehicle controllers may further include, after the stopping of the charging of the auxiliary battery, generating a warning sound or a warning message for preventing discharge of the auxiliary battery.

### BRIEF DESCRIPTION OF THE DRAWINGS

The above and other objects, features and advantages of the present disclosure will be more apparent from the following detailed description taken in conjunction with the accompanying drawings.

FIG. 1 is a flowchart for describing a method for preventing discharge of a battery at a time of re-programming of vehicle controllers according to an exemplary embodiment of the present disclosure.

### DETAILED DESCRIPTION

Advantages and features of the present disclosure and methods for accomplishing them will become apparent from exemplary embodiments described below in detail with reference to the accompanying drawings. However, the present disclosure is not limited to exemplary embodiments described herein, but may be implemented in other forms. These exemplary embodiments are provided in order to describe the present disclosure in detail so that those skilled in the art to which the present disclosure pertains may easily practice the spirit of the present disclosure.

In the accompanying drawings, exemplary embodiments of the present disclosure are not limited to illustrated specific forms, and may be exaggerated for the purpose of clarity. Although specific terms have been used in the present specification, they are used in order to describe the present disclosure and are not used in order to limit the meaning or the scope of the present disclosure, which is disclosed in the appended claims.

In the present specification, a term ‘and/or’ is used as the meaning including at least one of components arranged before and after the term. In addition, terms ‘connected/coupled’ are used as meaning that any component is directly connected to another component or is indirectly connected to another component through the other component. Unless explicitly described to the contrary, a singular form includes a plural form in the present specification. In addition, components, steps, operations, and elements mentioned by terms ‘include’ or ‘including’ used in the present specification may mean the existence or addition of one or more other components, steps, operations and elements.

Hereinafter, an exemplary embodiment of the present disclosure will be described in detail with reference to the accompanying drawings.

A system for re-programming controllers of a vehicle, or vehicle controllers, according to an exemplary embodiment of the present disclosure may include a re-programming tool of the vehicle and an external tool, and may decide whether or not to enter a re-programming mode or a normal mode.

A method by which the system for re-programming controllers of a vehicle performs re-programming will be described below.

First, the system for re-programming vehicle controllers may decide whether or not to enter the re-programming mode, and the vehicle controllers may enter the re-programming mode.

Next, the system for re-programming vehicle controllers may stop controller area network (CAN) communication between the vehicle controllers, and perform the re-programming of the controllers of the vehicle.

Next, the system for re-programming vehicle controllers may resume the CAN communication between the vehicle controllers after completing the re-programming of the vehicle controllers.

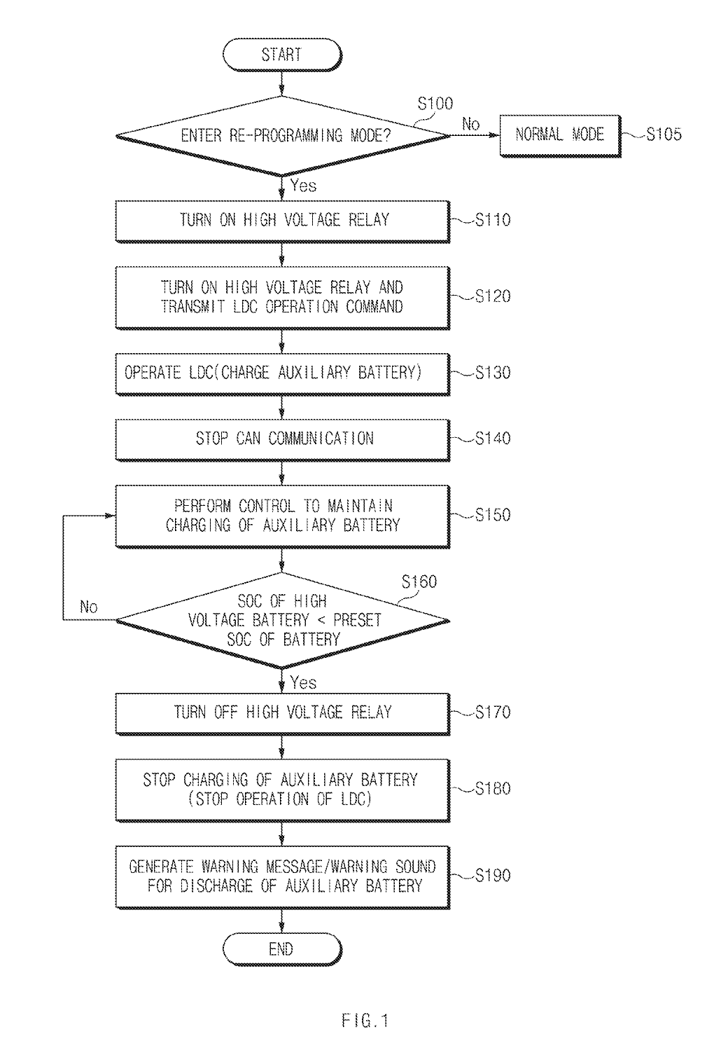

FIG. 1 is a flowchart for describing a method for preventing discharge of a battery at a time of re-programming of vehicle controllers according to an exemplary embodiment of the present disclosure.

Referring to FIG. 1, the system for re-programming controllers of a vehicle, or vehicle controllers, may enter the re-programming mode (S100).

However, when the system for re-programming vehicle controllers does not enter the re-programming mode, the system for re-programming vehicle controllers may enter the normal mode, such that the system for re-programming vehicle controllers may not perform the re-programming (S105).

Next, a battery management system (BMS) among the vehicle controllers may turn on a high voltage relay, and a low direct current (DC) to DC converter (LDC) among the vehicle controllers may be operated to charge an auxiliary battery when the high voltage relay is turned on (S110 to S130).

In detail, when the BMS and the LDC recognize a re-programming entry signal, the BMS and the LDC may start to charge the auxiliary battery.

Next, CAN communication between vehicle controllers except for the BMS and LDC may be stopped (S140).

Next, the BMS and the LDC may perform a control to maintain the charging of the auxiliary battery (S150).

Next, the BMS controls a high voltage battery and the high voltage relay in order to prevent a discharge of the high voltage battery (S160 and S170).

In detail, the BMS may compare a state of charge (SOC) of the high voltage battery with a preset SOC of a battery.

That is, the BMS may turn off the high voltage relay when the SOC of the high voltage battery is smaller than the preset SOC of the battery, and maintain a turn-on state of the high voltage relay to continuously request the LDC to charge the auxiliary battery and allow the LDC to maintain the charging of the auxiliary battery when the SOC of the high voltage battery is larger than the preset SOC of the battery.

Next, when the high voltage relay is turned off, the LDC may stop the charging of the auxiliary battery (S180).

Next, the system for re-programming vehicle controllers may generate a warning sound or a warning message so as to induce external charging in order to prevent a discharge of the auxiliary battery (S190).

As described above, the present technology is a technology capable of preventing the discharge of the auxiliary battery by prohibiting the CAN communication between the vehicle controllers at a time of reprogramming the vehicle controllers.

In addition, the present technology is a technology of performing the re-programming of the vehicle controllers while performing the charging of the auxiliary battery through cooperation between vehicle controllers as small as possible, or as few or little as possible, for charging the auxiliary battery.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preventing a discharge of a battery at a time of re-programming of vehicle controllers, comprising:
starting the re-programming by the vehicle controllers;
turning on a high voltage relay by a battery management system (BMS) among the vehicle controllers;
charging an auxiliary battery by operating a low direct current (DC) to DC converter (LDC) among the vehicle controllers;
stopping a controller area network (CAN) communication between the vehicle controllers;
controlling a high voltage battery by the BMS; and
stopping the charging of the auxiliary battery.

2. The method for preventing discharge of a battery at the time of re-programming of vehicle controllers according to claim 1, wherein the step of controlling the high voltage battery includes:
comparing a state of charge (SOC) of the high voltage battery with a preset SOC; and
turning off the high voltage relay in a case in which the SOC of the high voltage battery is smaller than the preset SOC.

3. The method for preventing discharge of a battery at the time of re-programming of vehicle controllers according to claim 2, wherein the step of charging the auxiliary battery is maintained in the case in which the SOC of the high voltage battery is larger than the preset SOC.

4. The method for preventing discharge of a battery at the time of re-programming of vehicle controllers according to claim 1, wherein in the step of starting the re-programming, when a system for re-programming the vehicle controllers does not enter a re-programming mode, the system for re-programming the vehicle controllers enters a normal mode.

5. The method for preventing discharge of a battery at the time of re-programming of vehicle controllers to claim 1, wherein in the step of stopping the CAN communication between the vehicle controllers, CAN communication between vehicle controllers except for the BMS and the LDC is stopped.

6. The method for preventing discharge of a battery at the time of re-programming of vehicle controllers according to claim 1, wherein a process of performing the re-programming includes:
deciding whether or not to enter a re-programming mode;
allowing the vehicle controllers to enter the re-programming mode;
stopping CAN communication between the vehicle controllers;
performing the re-programming of the vehicle controllers; and
resuming the CAN communication between the vehicle controllers.

7. The method for preventing discharge of a battery at the time of re-programming of vehicle controllers according to claim 1, further comprising, after the step of stopping the charging of the auxiliary battery, generating a warning sound or a warning message for preventing discharge of the auxiliary battery.
